(19) United States
(12) Patent Application Publication
(10) Pub. No.: US 2018/0258005 A1
(43) Pub. Date: Sep. 13, 2018

(54) Coated Fertilizer Compositions with a Biodegradable Coating Matrix

(71) Applicant: Mustapha Benmoussa, Albany, NY (US)

(72) Inventor: Mustapha Benmoussa, Albany, NY (US)

(21) Appl. No.: 15/844,481

(22) Filed: Dec. 15, 2017

Related U.S. Application Data
(60) Provisional application No. 62/474,102, filed on Mar. 21, 2017.

(30) Foreign Application Priority Data
Mar. 8, 2017 (MA) 40103

(51) Int. Cl. C05G 3/00; C05B 7/00; C05B 17/00; C05B 1/04; C05D 9/02; C09D 105/00

(52) U.S. Cl. CPC C05G 3/0029; C05G 3/0041; C05B 7/00; C09D 105/00; C05B 1/04; C05D 9/02; C05B 17/00

(57) ABSTRACT

A coating matrix operable for coating fertilizer particles. The coating matrix is made from a whole biomass composition, in which said whole biomass composition comprises at least a microalgae and a macroalgae reduced to a powder form, mixed with an aqueous solution of alkali metal hydroxide or alkaline earth metal hydroxide at a concentration ranging from 0.1% to 20% (w/v). The mixture is mixed at about 7 pH to about 9.5 pH which produces a cross-linked polysaccharide.

### CROSS-REFERENCE TO RELATED APPLICATIONS

The present Utility patent application claims priority benefit of the U.S. provisional application for patent Ser. No. 62/474,102 entitled “COATING FOR FERTILIZERS QUALITY AND EFFICIENCY IMPROVEMENT AND PROCESS FOR THE PREPARATION THEREOF,” filed on 21 Mar. 2017 under 35 U.S.C. 119(e). The contents of this related provisional application are incorporated herein by reference for all purposes to the extent that such subject matter is not inconsistent herewith or limiting hereof. Morocco patent application No. 40103 filed on 8 Mar. 2017 under 35 U.S.C. 119(a).

### BACKGROUND OF THE RELEVANT PRIOR ART

One or more embodiments of the invention generally relate to fertilizer compositions and process for preparing the fertilizer compositions. More particularly, certain embodiments of the invention relate to coated fertilizer compositions with a coating matrix that improves quality and efficiency of granular fertilizers.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. Fertilizers are one of the major factors that influence agriculture efficiency at the base of food security chain. Fertilizers may be delivered to farmers in a granular, powder, liquid or any other form. Typically, agrochemical fertilizers are granulated in the last phase of the production and dried. The objective of this step is to give the granules a physical stability for its easy handling. However, there is a dust, caking and softness generation problem during production, storage, and transport. Fertilizers granules are broken into debris and dust, which make them difficult to handle and distribute. It may result in atmospheric pollution, safety issues to handler, waste of fertilizers, and significant reduction in the quality.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that many attempts have been made to improve quality of granular fertilizers, minerals etc. and reduce air born dust as customers typically require granulated fertilizers that don't emit dust, reduced caking and improved hardness. Generally anti-dust coating products are rich in waxes, petroleum based products, starch, other polysaccharides, glycerin, polyethylene glycol, molasses, triethanolamine, polyvinyl, lignosulfonates, gypsum and mineral oils. All these components could be used alone or blended. It is believed that there many disadvantages in using some of these components such as petroleum based products and waxes. Waxes may be difficult to handle, and may not completely spread or coat the granulated fertilizers below their melting point, and they have limited binding properties. Petroleum based surfactants, mineral oils and kerosene, are considered hazardous due to their low flash point which could be a source of fire in the plants using them. They deteriorate the quality and functionality of the conveyor belt in the phosphoric acid plant. When mineral oils are used as anti-caking agent, they may make granules swells and weaker to generate dust during handling. The application of these products over a period could influence water absorption capacity of the soil, and may reduce the fertility of the soil. A wide variety of particle coating materials have been developed from synthetic polymers, waxes, petroleum based products, starch, glycerin, polyethylene glycol, molasses, Triethanolamine, polyvinyl, lignosulfonates, gypsum and mineral oils. Unfortunately, many coating material ingredients could be toxic and could disturb microorganism physiology and activity then the rhizosphere (soil) ecosystem. Research and development programs had been focused on the last two decades on the development of environmentally friendly biomaterials with coating properties. Many biosynthetic ingredients have been used such as polysaccharides, vegetable oil, wax (U.S. Pat. No. 8,979,970; US 20140345342). Biodegradability is the common properties which is the main advantage of these biosynthetic molecules. Biopolymers like chitosan, starch, cellulose etc. were used after chemical modification to form film and improve particles physical properties as coating materials. Many biomass end processing products were also used as ingredients in the development of coating biomaterials such as oilseeds meal, flour, recycled pulp fiber, water sludge from fermentation process etc. by adding oils or wax as dispersants (U.S. Pat. No. 9,321,699; U.S. Pat. No. 8,497,229, U.S. Pat. No. 8,506,671) to reduce the production cost of coating material and make the process commercially feasible.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a process flow chart for the manufacturing of a coating matrix product, in accordance with an embodiment of the present invention; and

FIG. 2 illustrates a process flow chart for the manufacturing of a coating matrix product, in accordance with an embodiment of the present invention.

### DETAILED DESCRIPTION OF SOME EMBODIMENTS

The present invention is best understood by reference to the examples and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human, animal or non-human (e.g. plants) user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The following definitions are provided to determine how terms are used in this application, and the way how claims are to be construed. The organization of the definitions is for convenience only and is not intended to limit any of the definitions to any category.

As used herein the term “Particulate material” or “particle” means a material that has a tendency to form dust particles when handled, processed, or contacted, which includes but is not limited to coal, dirt, wood chips, agricultural products, fruits, microorganisms, spores, vegetables, fertilizers, ores, mineral ores, fine materials, sand, gravel, soil, processed, cosmetic product, nutrients, (liquid, solid or in between) or other dust generating material, and any combination thereof.

As used herein, the term “Wet biomass” means biomass with about 50 to 99.9 percent water content. It may be appreciated by a person with ordinary skill in the art, in light of and in accordance with the teachings of the present invention, that the water could be present inside cells or tissues (internally) and/or surrounding cells or tissues (externally). As used herein, the term “Dry biomass” means biomass with about 0 to 49.99 percent water content.

As used herein the term “Matrix” means any material, with more than one component, not limited to surrounding a stricture or particle.

As used herein the term “Blend” means a mix, mixture, combination between internal or external components (chemicals).

As used herein, the term “native blend” means a mix, mixture, combination between biomass, tissue and cell internal components.

As used herein, the term “homogenization” means a cell wall, membrane, and organelles disruption, and separation of cell small and large molecules, and native ions from each other.

As used herein, the term “chemical initiation” means internal and external small and large molecules, and native ions from each other started to be cross-linked between each other.

As used herein, the term “native chemical initiation” means separated cell internal small and large molecules, and native ions from each other started to be cross-linked between each other.

As used herein, the term “web or web blend” means a network developed in the matrix, blend or native blend.

In various embodiments, the invention disclosed herein includes advantages of whole biomass as a source of a coating matrix. It may be appreciated by a person with ordinary skill in the art, in light of and in accordance with the teachings of the present invention, that green biomass is a sustainable source of biopolymers. As environmentally friendly polymers, they may be used as coating agent of particles for human, animal, plant and soil uses. Moreover, the whole biomass being rich in micronutrients may benefit human, animal, plant, and microorganisms in soil. Whole biomass may be obtained from terrestrial or aquatic plant. Land plant biomass may include waste or whole plants. Aquatic plants such as macroalgae and microalgae also constitute a potential biomass source.

Seaweed is a sustainable whole biomass and could be an alternative to land crop biomass in many industries in the future. Whole seaweed biomass analysis demonstrated the presence of growth promoting hormones, IAA, IBA, Cytokinins, Gibberellins, trace mineral elements, polysaccharides, proteins, lipids, vitamins, amino acids and micronutrients (Zodape et al, 2008). The protein content of seaweed varieties varies greatly. For example, the protein content of brown algae species, e.g., Laminaria japonica, Hizikia fusiforme or Underlie pinnatifid a, protein content is 7-16 g/100 g dry weight (d.w.). In contrast, red algae, e.g., Palmaria palmata (Dulse) and Porphyra tenera contain 21-47 g protein/100 g (d.w.) (Ruperez & Saura-Calixto, 2001). This seaweed (macroalgae) and microalgae biomasses are considered nutritionally rich, and cell components constitute the base of the aquatic food chain. Polysaccharides, as part of these cell components, are the most popular commercial seaweed extracts e.g. alginate, carrageenan, agar, fucoidan, laminaran. They are generally used as thickening or gelling agents in many industries such as food, beverages, adhesives.

Polysaccharides were previously added to other chemicals such as oil, wax etc. to change viscosity and form films and coating materials (i.e. U.S. Pat. No. 8,506,671). Although, using only seaweed extracts (polysaccharides) in previously applied inventions, the present invention report the use of the whole seaweed biomass. The use of whole seaweed biomass after its homogenization comprises using all the cell components of the seaweed (e.g. none wasted) including lipids (oil), proteins, vitamins, mineral chemicals (macronutrients, secondary nutrients and micronutrients), growth hormones, polysaccharides, simple sugars, amino acids, antioxidants, water, etc. In the present invention, all the seaweed cell components from homogenized whole seaweed biomass are mixed and processed the way that they play a role in the development of a coating bio-matrix with desired viscoelastic property and respond to the commercial standards required.

The required commercial standards of a particle coating biomaterial are for example improved anti-caking, anti-dusting, crushing strength, isolate the particle from the surrounding environmental influence such as hold particle internal humidity, during processing, storage, transportation or any kind of handling.

The whole seaweed coating matrix is also rich in micronutrients with, vitamins, amino acids, simple sugars, growth promoting hormones like IAA, IBA, Cytokinins, Gibberellins, proteins, lipids, polysaccharides, antioxidants etc. Which they are playing a fertilizer role as plant growth bio-stimulant is another advantage comparatively to other inventions. No component in whole seaweed coating blend product is associated with any toxicity property which is also another environmentally friendly advantage.

The mineral fraction in the whole seaweed coating blend is a major player in the improvement of its physical and chemical properties. This modification could be adjusted to provide the desired viscoelastic characteristic based on the end use such as a coating biomaterial matrix.

The mineral fraction in brown seaweed biomass contains higher amounts of both macrominerals and micronutrients than those reported for edible land plants (Ruperez, 2002). Chemical analysis showed that they account from 8.08 to 17,875 mg/100 g dry weight biomass of Na, K, Ca, and Mg. Trace elements named micronutrients accounts 5.1-15.2 mg/100 g of Fe, Zn, Mn, Cu.

The mineral seaweed composition consists of high percentage of many micronutrients that may be used for plant growth including, but not limited to fertilizers and essential trace elements for human nutrition including, but not limited to vitamins and animal nutrition including, but not limited to animal feeds. In the meantime, this mineral composition such as iron, zinc and magnesium are usually used for polymers cross-linking. Adding, optionally, some of these elements to the native blend could improve the cross-linking process. For example, extracted polysaccharides such as cellulose, lignocellulose, chitosan, alginate etc. were cross-linked to change their physical properties. Elements like Ca, Z, Fe, Mg were used before to polysaccharides in solution to create cross-linking at temperature over 80 degree Celsius for more than 120 min (Bruchet et al., 2015).

The native presence of mineral elements may be totally or partially used in the internal cross-linking process. In the present invention, the mineral fraction plays also a fertilizers role and source micronutrients necessary for human nutrition such as, but not limited to vitamins, animal nutrition such as, but not limited to animal feeds, and crop nutrition such as, but not limited to fertilizers. Most of these elements, if not all of them, may be used in the homogenized whole seaweed biomass cross-linking between polymers. The process may use all the (whole) seaweed biomass components where only a minimal amount of seaweed biomass may be wasted and develop a native blend.

In one embodiment, the present invention is divided into two phases. The first phase may include the methodology of end-product development which is the whole seaweed homogenized blend. This phase is called whole biomass processing. The second phase may include potential commercial uses of the homogenized whole biomass blend named potential uses.

Phase I: Whole Biomass Processing

In one embodiment, the whole seaweed biomass processing phase may include 1) pretreatment, 2) homogenization and chemical modification and 3) end-product post treatment steps.

1) Pretreatment

In one embodiment, the pretreatment is an optional step that may improve the yield and lower the processing cost in the next steps. Pretreatment may depend on the seaweed species and the biomass condition e.g. dry or wet biomass. In some cases, pretreatment methods of processing begin with a physical and/or chemical preparation of the whole biomass, e.g., mechanical methods to reduce the size and/or dimensions of individual pieces of the whole biomass or make them in the form of powder, for example by cutting, grinding, crushing, smashing, shearing, chopping, shredding, hammer milling, roller milling and a flaker mill. In certain embodiments, a freezing step may improve also the whole process such as using liquid nitrogen, low freezing temperature, freeze dryer.

In some embodiments, pretreatment methods of processing begin with a physical and/or chemical preparation of the whole biomass, e.g., mechanical methods to reduce the size and/or dimensions of individual pieces of the whole biomass, such as by cutting, grinding, crushing, smashing, shearing or chopping. A roller mill/cracker mill can generally be described as a device with two or more rolls each containing longitudinal grooves which assist in further size reduction of material fed through the mill. Various size roller mills exist and may be useful in chopping the plant matter such as those containing openings of ¾″, ½″, ⅜″, ¼″ and ⅛″. The whole biomass is subjected to at least one of a shredder, a granulator, a hammer mill, a roller mill and a flaker mill to produce chopped plant matter having an average size of 1″ or less. The whole biomass may be subjected to at least shredding/chopping, hammer milling, roller milling and a flaker mill. Screens and/or magnets may be used to remove oversized or undesirable objects such as, for example, rocks and sand from the feed stream.

In some embodiments, a synergistic effect of mechanical and chemical such as high pH pretreatment may be used to improve the yield and the quality of the end-product. A base may be used to increase the pH (e.g., pH between 7.5 and 14) for example sodium hydroxide, potassium hydroxide, sodium carbonate, etc. The pretreatment time may include hold time with or without mixing or stirring for about 5 min to about 3 days, even more under some circumstances, to develop a pretreated biomass easy to homogenize and initiate chemical modification for the development of a desired viscoelastic property of the end-product blend. Pretreatment is an optional step where it improves the efficiency of the homogenization process.

2) Homogenization and Chemical Modification

The goal of this step is to disperse and solubilize all the cell components of the whole biomass then initiate an interaction process between them such as cross-linking. The mechanical process may be combined with heating and mixing at high pH (e.g., pH between 7.5 and 14 at a temperature about 40 to about 65° C.).

Washing pretreated whole seaweed biomass from the pretreatment step is optional and depends on the type of pretreatment, the species used and their cell composition. Various techniques could be used to homogenize cells and liberate the maximum of nutrients. Enzymes could be used such as cellulosic enzymes, to break down cell wall into shorter chain oligosaccharides. Physical techniques include fine grinding, homogenizing, collisions with beads, shearing, cutting, crushing, smashing, or using grinding machines.

In the beginning of the homogenization step, the washing of the pretreated biomass with freshwater may be performed especially if the enzymatic treatment is involved in the homogenization step. It is well known that the cell wall enzymes have an optimum of activity under acidic pH. The pH could be then adjusted during or after the washing step to reach a pH value for an optimal enzymatic activity. In certain embodiments, there are some cell components, that play roles in physical, chemical and nutritive properties, may be wasted out, and it may then influence the quality of the end-product. It may be appreciated by a person with ordinary skill in the art, in light of and in accordance with the teachings of the present invention, that the washing step may be involved based on the end use of the blend. In certain embodiment, when whole seaweed cell components are used during the processing to produce a blend with desired viscoelastic properties for example to form film, coating bio-material etc., the washing step of pretreated biomass may not be preferred.

In one embodiment, the homogenization of the whole biomass process is the main step. As mentioned above, pretreated whole biomass may improve the process and the desired end-product properties. The whole biomass is first mixed with alkaline solution (called aqueous solution) at high pH (e.g., pH between 7.5 and 14). It may be appreciated by a person with ordinary skill in the art, in light of and in accordance with the teachings of the present invention, that pH will depend on the target physical/chemical properties and the purpose of the end-product.

In various embodiments, homogenization may be performed by mechanical means as mentioned above. The physical and/or chemical preparation of the whole biomass, e.g., mechanical methods to reduce the size and/or dimensions of individual pieces of biomass, such as by cutting, grinding, crushing, smashing, shearing or chopping. The homogenization could be on pretreated or none-pretreated whole seaweed biomass.

Alkaline solution disturbs cell wall, membrane, and organelles components followed by agglomerated (or polymerized) cell components (agglomeration or polymerization). They are interconnected in the way they form a kind of web with intra and inter liaisons. The aqueous solution at high pH is made by solubilizing a base in fresh water. It is preferred to use only fresh water as liquid. Other chemicals may be added to the aqueous solution based on the target physical/chemical properties and the type of the end-product uses such as adding oils and/or other dispersants. The pH is adjusted using a base like sodium hydroxide, potassium hydroxide, calcium hydroxide, sodium carbonate or a combination of at least two on them.

In one embodiment, the homogenization step may be combined in one phase or divided into two phases (homogenization and chemical modification). In one embodiment, the temperature in the first phase of homogenization step may be in a range of from about 30 degrees Celsius to about 121 degrees Celsius. In another embodiment, the temperature in the first phase of homogenization step may be in a range of from about 32 degrees Celsius to about 60 degrees Celsius. In yet another embodiment, the temperature in the first phase of homogenization step may be in a range of from about 35 degrees Celsius to about 42 degrees Celsius. In one embodiment, in the first homogenization phase, biomass or pretreated biomass may be homogenized under frozen state for example: the biomass is grinded in the presence of liquid nitrogen.

In one embodiment, the time taken for the first phase of homogenization step may be in a range of from about 30 seconds to about 24 hours. In another embodiment, the time taken for the first phase of homogenization step may be in a range of from about 10 minutes to about 180 minutes. In yet another embodiment, the time taken for the first phase of homogenization step may be in a range of from about 5 minutes to about 60 minutes. In one embodiment, the time taken for the first phase of homogenization step may be about 20 min.

In one embodiment, the temperature in the second phase of homogenization step i.e., may be called homogenization/chemical modification step may be in a range of from about 40 degrees Celsius to about 70 degrees Celsius. In another embodiment, the temperature in the second phase of homogenization step may be in a range of from about 41 degrees Celsius to about 60 degrees Celsius. In yet another embodiment, the temperature in the second phase of homogenization step may be about 35 degrees Celsius 42 degrees Celsius.

In one embodiment, the time taken for the second phase of homogenization step may be in a range of from about 60 seconds to about 24 hours. In another embodiment, the time taken for the second phase of homogenization step may be in a range of from about 20 minutes to about 180 minutes. In yet another embodiment, the time taken for the second phase of homogenization step may be in a range of from about 30 minutes to about 100 minutes. In one embodiment, the time taken for the second phase of homogenization step may be about 60 min.

In one embodiment, the homogenization may be carried out in a single phase. in such an event, the temperature in the second phase of homogenization step which may be called homogenization/chemical modification, may in one embodiment, be in a range of from about 40 degrees Celsius to about 121 degrees Celsius. In another embodiment, the temperature in the second phase of homogenization step may be in a range of from about 41 degrees Celsius to about 60 degrees Celsius. In yet another embodiment, the temperature in the second phase of homogenization step may be about 42 degrees Celsius. Accordingly, the time taken for the second phase of homogenization step which may be called homogenization/chemical modification, may in one embodiment, be in a range of from about 60 seconds to about 24 hours. In another embodiment, the time taken for the second phase of homogenization step may be in a range of from about 20 minutes to about 180 minutes. In yet another embodiment, the time taken for the second phase of homogenization step may be in a range of from about 30 minutes to about 100 minutes. In one embodiment, the time taken for the second phase of homogenization step may be about 60 min.

It may be appreciated by a person with ordinary skill in the art, in light of and in accordance with the teachings of the present invention, that the temperature and the period of processing are two interrelated parameters. Both parameter could be determined based on end-product target physical/chemical properties and purpose of its use (commercial application). For example, if the end-product is a promoting plant growth, a low processing temperature with a less aggressive base will contribute in conserving cell components biological activity. The preferred temperature could be below 70 degrees Celsius. The processing step cost is a determinant factor. Balance between temperature and the period of processing and yield optimization with the end-product appropriate physical/chemical properties and its use commercial application target. High temperature will contribute in reducing processing time.

It may be appreciated by a person with ordinary skill in the art, in light of and in accordance with the teachings of the present invention, that the processing method may be adjusted based on the seaweed species and the cell composition and the content (percentage) of each class of component. Heating temperature, heating time, pH, etc. could be then properly adjusted. For example, the polysaccharide content change along the year (harvesting time), the location, and drying condition in case dry biomass is used as biomass source, and storing condition. For example, when polysaccharide such as alginate composition is below 25 percent, it is preferred to add more polysaccharides like alginate to reach a percentage over 35 percent. Generally, the adjustment includes heating conditions, pH conditions, pretreatment, type and time of homogenization method etc.

During the homogenization process, cell walls and membranes are disturbed and all the cell components are dispersed. The whole process could influence the molecular weight of polymers. For example, heating at temperature over 80 degrees Celsius in high pH solution for over 30 min of processing could degrade polymers and change the chemical and physical properties of the new web blend from the native blend. It may be appreciated by a person with ordinary skill in the art, in light of and in accordance with the teachings of the present invention, that to form a web blend is a mix of native cell components with desired physical properties to form a film surrounding particles.

Furthermore, the polymeric material of the homogenized biomass can be cross-linked at high pH e.g. pH between 7.5 and 10. Lipids are hydrolyzed, glycerol and fatty acid liberated. Glycerol as plasticizer, fatty acids as dispersants

In various embodiments, the advantages of soft warming may include retaining biological activity of cell components such as vitamins, antioxidants, plant growth hormones, pigments, etc. Soft warming means the homogenizing and blending steps are performed at a warm temperature hold. For example: to develop a blend coating end-product that improve fertilizer particles required commercial standards, the homogenization and chemical modification temperature is about 42 degrees Celsius to about 50 degrees Celsius for a period of about 60 minutes.

3) End-Product Post Treatment

In one embodiment, this step is focused on blend fortification by secondary micronutrients and chemical modification of the solubilized and dispersed whole biomass components, or any other chemical or biological material that may contribute in modifying the physical chemical composition and properties based on the end use of the blend product.

Micronutrients are chemicals required by the plant to grow and perform normal physiological functionality. These micronutrients are used in small quantity such as boron (B), chlorine (Cl), copper (Cu), iron (Fe), manganese (Mn), molybdenum (Mo), and zinc (Zn). Although, Cl, Fe, B, Mn, Zn, Cu, Mo, and Ni exist already in homogenized whole seaweed biomass blend originally from seaweed biomass source. Adding them to the blend will improve physical/chemical properties, viscosity, and nutritive value. Elements like Fe and Zn will initiate more cross-linking. The added concentration of Fe and Zn is about 0.1 mg to 50 mg/kg particles. Secondary nutrients including calcium (Ca), magnesium (Mg), and sulfur (S) could be added to the blend. For example, added Mg is about 0.1 to 100 mg/kg particles. Micronutrients and/or secondary nutrients are optionally added in the end-product post treatment or in homogenization steps. In one embodiment, micronutrients may be added after adjusting the pH which may improve the blend (matrix) quality (physical property).

During processing (homogenization) there is hydrolysis of lipids with liberation of fatty acids and glycerin (glycerol). Glycerin is playing a plasticizer and intermolecular liaison role among the blend web of components. In one embodiment, addition of an extra glycerin is preferred at about 0.1 to 10 percent v/v of the homogenized blend if oil is added to hydrolyze the oil to glycerin and fatty acids. Addition of vegetable oil is preferred at about 1 to 10 percent v/v of the homogenized blend.

The pH is adjusted about 7.5 to 9.5. Soft warming and mixing are preferred parameters. It is more preferred that the warming is about 40 to 60 degree Celsius for about 5 to about 60 min period. The mixing speed is about 25 to about 5000 RPM (rotation per minute) and over. It is preferred that the warming and/or mixing period exceeds 60 min. Alternatively, the warming and mixing steps may take about 5 mins to 24 hours. However, sixty (60) minutes may provide good results.

The end-product viscosity depends on the end-use. The viscosity is about 50 cps to about 100000 cps at 25 degree Celsius.

Phase II: General Uses of the Blend (End-Products)

The homogenized whole seaweed blend is also a highly-concentrated and viscous product that may have all the nutritive chemicals to be used as human food, animal feed, coating particles, fertilizer, or carrier etc. For example, the homogenized whole seaweed blend is a potential carrier of many components such as micronutrients, pesticides, insecticides, bio pesticides, microorganisms for crop protection and/or biofertilization.

It may be appreciated by a person with ordinary skill in the art, in light of and in accordance with the teachings of the present invention, that the level of the concentrate and viscosity parameters is adjusted based on end uses, logistics, handling and customer requirements. In one embodiment, the pH may be adjusted to a value in range of from about 7 to about 9.5 pH.

In one embodiment, the concentrate blend is diluted and solubilized then used as a plant bio stimulant to promote the growth. The concentration depends on the variety of plant, its growth phase and environmental conditions. In one embodiment, the blend concentrate is added to water or any aqueous solution about 10 g/liter to about 500 g/liter (blend concentrate/water). In another embodiment, the blend concentrate is added to water or any aqueous solution about 45 g/L to about 200 g/L. In yet another embodiment, the blend concentrate is added to water or any aqueous solution about 35 g/L to about 50 g/L. The diluted product may be applied as foliar spray or for root absorption. It may be used by itself or combined with liquid or solid fertilizers, pesticides, bio-pesticides, and/or microorganisms. For example, the application at early stage contribute in good root development that may help plant to tolerate salinity and dryness.

In various embodiments, the concentrate blend may have physical proprieties to be used as coating biomaterials of particles such as fertilizers, fruits, vegetables, seeds, microorganisms, coal etc. Microorganisms could be bacteria, fungi, or any microscopic live organism. These microorganisms may play the role of biofertilizer or in the crop protection. The blend and microorganisms are mixed, granulated then dried at a temperature of less than about 45 degrees Celsius. Other ingredients may be added to the mix such as fertilizer, silica etc. For example, the biomass blend will be used by microorganisms as nutrients booster under moisture condition in the soil when they were applied in the field. The concentration of microorganisms depends on the variety of plants, its growth phase and environmental conditions.

In one embodiment, the concentrate blend may be used as seed coating material. The presence of polysaccharides in the blend will allow the coated seeds to hold humidity in soil surrounding the seed, seedling or small plant. The presence of nutrients in the blend is used as growth booster of seedling and small plant. The coating blend is used at a ratio of about 5 to 20%, about 5 to about 10%, it is about 10 percent and contribute in the improvement of plant tolerance to salinity and dryness.

In one embodiment, the concentrate blend may be used as fertilizer coating material. In one embodiment, an amount of about 1 g to about 10 g of the concentrate blend may be mixed with 1 kg of fertilizer. In another embodiment, an amount of about 2.5 g to about 5 g of the concentrate blend may be mixed with 1 kg of fertilizer. In yet another embodiment, an amount of about 3 g of the concentrate blend may be mixed with 1 kg of fertilizer. Drying of the coated fertilizer is optional.

Accordingly, in one embodiment, a coating matrix may be provided. The coating matrix may include, but is not limited to, a homogenized whole biomass. In one embodiment, the homogenized whole biomass may be chemically modified. The coating matrix may improve the quality and efficiency of granular fertilizers, granular minerals and hydro soluble fertilizers. In one embodiment, the coating matrix may include whole biomass such as microalgae or macro algae called seaweed. A chemical modification step may be added to develop a viscoelastic property and form a film. This property may be used to cover particles such as granular or hydro soluble fertilizers or minerals and improve its quality from the granulation, transportation, and delivery.

Accordingly, in one embodiment, the whole biomass may include seaweed including but not limited to a micro algae, and a macroalgae. Cystoseira sp may be used as macroalgae. Microalgae may be at least one strain from genus Botryococcus, Chlorella, Skeletonema, Thalassiosira, Phaeodactylum, Chaetoceros, Cylindrotheca, Euglena, Bellerochea, Actinocyclus, Nitzchia, Cyclotella, Isochrysis, Pseudoisochrysis, Dicrateria, Monochrysis, Tetraselmis, Pyramimonas, Micromonas, Chroomonas, Cryptomonas, Rhodomonas, Chlamydomonas, Olisthodiscus, Carteria, Dunaliella, Spirulina et Nannochloropsis. Macroalgae may be at least one strain from orders: Laminariales, Macrocystis, Fucales, Ectocarpales, Chordariales, Dictyotales, Desmarestiales, Scytosiphonales, Dictyosiphonales et Sargassum, et les genres Cystoseira, Bifucaria, Nerocystis, Sargassum, Limanaria, Ectocarpus, Macricystis, Ulva, Pophyra, Palmaria, Lithothamnion et Ascophyllum.

In one embodiment, the whole biomass when used for manufacturing the coating matrix may be dry. However, the coating matrix may be wet to be used as a coating agent.

In one embodiment, the biomass when used for manufacturing the coating matrix may be wet. In one embodiment, the amount of water in the biomass may be in a range of from about 20 percent to about 99 percent weight by weight based on a total weight of the biomass. In another embodiment, the amount of water in the biomass may be in a range of from about 50 percent to about 80 percent weight by weight based on a total weight of the biomass. In yet another embodiment, the amount of water in the biomass may be in a range of from about 60 percent to about 70 percent weight by weight based on a total weight of the biomass.

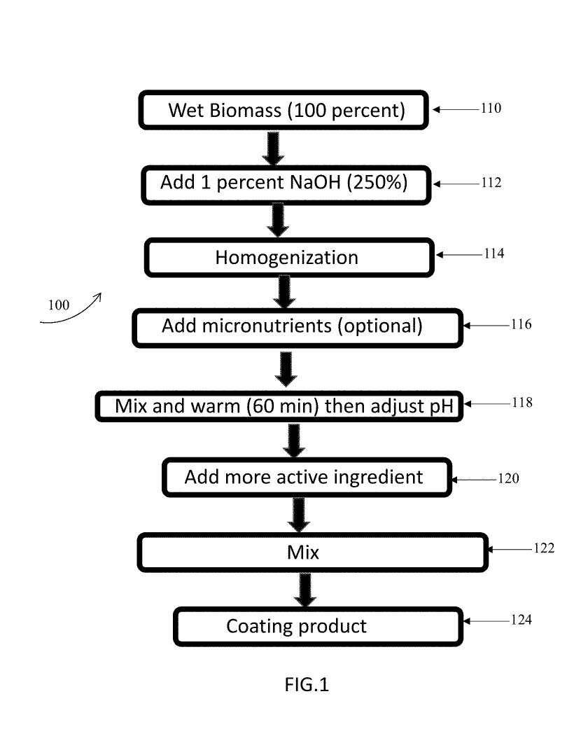

In one embodiment, a method for manufacturing the coating matrix and using the coating matrix to manufacture a coated fertilizer product is provided. Referring to FIG. 1 is provided a process flow chart 100 for the manufacturing of a coating matrix in accordance with an embodiment of the present invention. In a step 110 whole wet biomass is taken. The wet biomass may be used after a washing step and 100 percent is the baseline (it is considered 100%) in this case where water solution at high pH is 250% means proximately 2.5 times the starting wet biomass (if proximate 100 kg of wet biomass is used added to a proximate 250 kg water solution at high pH). In a step 112, aqueous solution of alkali metal hydroxide or alkaline earth metal hydroxide at a concentration ranging from approximately 0.1% (w/v) to 20%. may be added to the wet biomass to form an alkaline mixture. Suitable alkali metal hydroxides may include, but not be limited to, sodium hydroxide (NaOH), potassium hydroxide (KOH). Suitable alkaline earth metal hydroxides may include, but not be limited to, potassium hydroxide, calcium hydroxide, alkali metals, alkaline earth metals, ammonium hydroxide, ammonia, sodium carbonate, potassium carbonate, boron hydroxide, Aluminum hydroxide, borax, amino alcohols such as ethanolamine, diethanolamine, triethanolamine, isopropanolamine, diisopropylamine, triisopropylamine, propylamine, 2-propylamine, methylamine, dimethylamine, Trimethylamine, dimethylethanolamine, monoethylethanolamine, 2-(2-aminoethoxy) ethanol, diglycolamines, diethylamine or a mixture thereof. In case of whole dry biomass, the alkaline solution (1%) may be added at the proximate ratio of 7.5:1 (volume/weight)

In one embodiment, the concentration of alkali metal hydroxide employed in the process may be in in a range of from about 0.1 percent to about 20 percent weight of the aqueous solution. In another embodiment, the concentration of alkali metal hydroxide employed in the process may be in in a range of from about 1 percent to about 10 percent weight of the aqueous solution. In yet another embodiment, the concentration of alkali metal hydroxide employed in the process may be in in a range of from about 2 percent to about 5 percent weight of the aqueous solution. In one embodiment, the concentration of alkali metal hydroxide employed in the process may be about 1 percent weight of the aqueous solution

In one embodiment, the ratio of aqueous alkaline solution employed in the process may be in a range of from about 0.5:10 to about 8:10 weight by volume based on biomass or pretreated biomass/aqueous solution. In another embodiment, the ratio of aqueous alkaline solution employed in the process may be in in a range of from about 2:10 to about 6:10 weight by volume based on biomass or pretreated biomass/aqueous solution. In yet another embodiment, the ratio of aqueous alkaline solution employed in the process may be in in a range of from about 4:10 to about 5:10 weight by volume based on biomass or pretreated biomass/aqueous solution.

In one embodiment, the alkali earth metal or alkaline earth metal may be added to the biomass at a temperature in a range of from about 4 degrees Celsius to about 100 degrees Celsius. In another embodiment, the alkali earth metal or alkaline earth metal may be added to the biomass at a temperature in a range of from about 25 degrees Celsius to about 70 degrees Celsius. In yet another embodiment, the alkali earth metal or alkaline earth metal may be added to the biomass at a temperature in a range of from about 35 degrees Celsius to about 60 degrees Celsius.

In one embodiment, the resultant alkaline mixture may have a pH in a range of from about 7.5 pH Celsius to about 14 pH. In another embodiment, the resultant alkaline mixture may have a pH in a range of from about 8 pH Celsius to about 12 pH. In yet another embodiment, the resultant alkaline mixture may have a pH in a range of from about 10 pH Celsius to about 12 pH.

In a step 114 the alkaline mixture may be homogenized. The homogenization process may be carried out in a grinder. In one embodiment, water may be added to the alkaline mixture before homogenization. In one embodiment, the amount of water employed in the homogenization step 114 may be in in a range of from about 2.5 to about 10 weight by volume based on the weight of the alkaline biomass. In another embodiment, the amount of water employed in the homogenization step 114 may be in in a range of from about 2.5 to about 6 weight by volume based on the weight of the alkaline biomass. In yet another embodiment, the amount of water employed in the homogenization step 114 may be in in a range of from about 2.5 to about 4 weight by volume based on the weight of the alkaline biomass.

In one embodiment, a slurry obtained after the homogenization step 114 may be filtered. In another embodiment, a slurry obtained after the homogenization step 114 may not be filtered. The filtration is a quality control step to make sure that there may be no non-homogenized biomass or any other particle mixed with the slurry.

In one embodiment, after the homogenization step 114 the pH of the resultant slurry may be adjusted to a value in a range of form about 7 to about 9 pH. In another embodiment, after the homogenization step 114 the pH of the resultant slurry may be adjusted to a value in a range of form about 7.5 to about 14 pH. In yet another embodiment, after the homogenization step 114 the pH of the resultant slurry may be adjusted to a value in a range of form about 8 to about 12 pH.

In step 116 micronutrients may be added to the resultant slurry. Addition of micronutrients allows more cross-linking and improve the coating matrix viscosity and liaison between the blend components. Suitable examples of micronutrients may include, but not be limited to boron (B), copper (Cu), iron (Fe), manganese (Mn), molybdenum (Mo), zinc (Zn), chlorine (Cl), cobalt (Co), sodium (Na), and combinations thereof. Micronutrients influences plant growth and its metabolism and physiology. Micronutrients may be prescribed at low doseincluding secondary elements such as, but not limited to, Calcium (ca), magnesium (mg) and Sulfur (S) before the coating. These elements belong to the groups: lithium group including for example Na, Beryllium group including for example magnesium (Mg) and calcium (Ca), Chromium group including for example molybdenum (Mo), Manganese group including for example manganese (Mn), Iron group including for example iron (Fe), Cobalt group including for example cobalt (Co), Cooper group including for example copper (Cu), Zinc group including for example zinc (Zn), Boron group including for example boron (B), oxygen group including for example sulfur (S) and silicate (Si), and fluorine group including for example chlorine (Cl). In one embodiment, the amount of micronutrients added to the slurry may be in in a range of from about 0.01 to about 10% by weight based on the weight of the fertilizer composition. In another embodiment, the amount of micronutrients added to the slurry may be in in a range of from about 0.01 to about 5% by weight based on the weight of the blend. In yet another embodiment, the amount of micronutrients added to the slurry may be in in a range of from about 0.1 to about 2% by weight based on the weight of the blend.

In step 118, the homogenized slurry with micronutrients is mixed and then warmed and then the pH of the resultant slurry is adjusted to a value in a range of about 7.0 pH to about 14.0 pH. In one embodiment, the mixing may be carried out at a speed of about 25 rpm to about 5000 rpm. In another embodiment, the mixing may be carried out at a speed of about 50 rpm to about 500 rpm. In yet another embodiment, the mixing may be carried out at a speed of about 50 rpm to about 1000 rpm.

In one embodiment, mixing may be carried out at a temperature in a range of from about 20 degrees Celsius to about 121 degrees Celsius. In another embodiment, mixing may be carried out at a temperature in a range of from about 30 degrees Celsius to about 70 degrees Celsius. In yet another embodiment, mixing may be carried out at a temperature in a range of from about 35 degrees Celsius to about 65 degrees Celsius.

In one embodiment, the pH of the resultant slurry may be adjusted to a value in a range of form about 7 to about 14 pH. In another embodiment, the pH of the resultant slurry may be adjusted to a value in a range of form about 7.5 to about 12 pH. In yet another embodiment, the pH of the resultant slurry may be adjusted to a value in a range of form about 8 to about 10 pH. In an embodiment, pH adjustment may be performed after homogenization and adding micronutrients, oil and glycerol. A final adjustment may be performed as needed and based on the type of coating and costumer request.

In step 120, active ingredients may be added to the homogenized slurry obtained after step 118. Suitable active ingredients may include, but are not limited to, microorganisms, pesticides, etc. Microorganisms includes but not limited to Bacillus, Rhizobium, Azobacter, Azospirillum, Aspergillus, Mycorhizzae, Beauveria, Metarhizium, and Trichoderma, Saccharomyces, Schizosaccharomyces, Sporobolomyces, Candida, Trichosporon, and Rhodosporidium or in combination.

In one embodiment, the amount of active ingredients added may be based on a pesticides toxicity level. It may be in in a range of from about 500 mg/l to about 5000 mg/l based on slightly toxic pesticide level. In another embodiment, the amount of active ingredients added may be in in a range of from about 50 to about 500 based on moderately toxic pesticide level. In yet another embodiment, the amount of active ingredients added may be in in a range of from about 0 to about 50 based on highly toxic pesticide level. The amount may be over 5000 mg/L in case the pesticide are slightly toxic. Microorganisms were added to the blend when it is requested, and used and not limited to plant biocontrol, potassium or phosphorus solubilizing and mobilizing, nitrogen fixation. They are added to reach a final density may be in in a range of from about 10² to about 10¹⁰ cfu (colony forming units), may be in in a range of from about 10³ to about 10⁷ cfu, may be in in a range of from about 10⁴ to about 10⁶ cfu.

In step 122, the resultant mixture is mixed to form a coating matrix in step 124. Warming the resultant mixture after adding active ingredient is optional and it depend on the type of the active ingredient. For example, if the active ingredient is living microorganisms, the highest warming temperature should be 40 degree Celsius. If it is only oil which may be vegetal or mineral and glycerol (named also glycerin) the temperature may be higher for example up to 121. Warming improve and facilitate the interaction between added and existed components.

In one embodiment, the coating matrix may include combination of biopolymers and/or oligomers and/or monomers and/or antioxidants and/or vitamins and/or amino acids and/or carbohydrate and/or salts and/or lipids and/or proteins etc. The coating matrix are native or whole cell components comprising the whole biomass to improve the coating matrix properties. The coating matrix may include chemicals such as, but not limited to micronutrients, oil, glycerin etc.

In one embodiment, the mixture obtained after the addition of the active ingredients may be adjusted to have a particular viscosity by addition of a viscous agent. Suitable examples of viscous agents include, but are not limited to, vegetable oil, mineral oil. The vegetable oil source may be and not limited to microalgae, macroalgae, crops seeds, Jatropa, cooking oil. Glycerin may be used as crude, semi refined or refined ingredient. In one embodiment, the mixture may be adjusted to have a viscosity in a range of from about 100 centipoise (cp) to about 100000 cp at a temperature of about 25 degrees Celsius. In another embodiment, the mixture may be adjusted to have a viscosity in a range of from about 1000 cp to about 50000 cp at a temperature of about 25 degrees Celsius. In yet another embodiment, the mixture may be adjusted to have a viscosity in a range of from about 5000 cp to about 25000 cp at a temperature of about 25 degrees Celsius. In one embodiment, the amount of viscous agent added may be in in a range of from about 0.1 percent to about 98 percent weight by weight based on the weight of the coating mixture. In another embodiment, the amount of viscous agent added may be in in a range of from about 1 percent to about 50 percent weight by weight based on the weight of the coating mixture. In yet another embodiment, the amount of viscous agent added may be in in a range of from about 3 percent to about 10 percent weight by weight based on the weight of the coating mixture.

In one embodiment, the coating matrix manufactured as described in FIG. 1 may be maintained at a temperature of about 60 degrees Celsius for a period of about 60 minutes before its application as a coating matrix. The matrix viscosity is low when temperature increase. Both matrix and particles should be warmed for better film forming and matrix surrounding the particle.

In one embodiment, the coating matrix may form a film having a thickness in a range of form about 0.01 microns to about 42 microns on the surface of the fertilizer granules. In another embodiment, the coating matrix may form a film having a thickness in a range of form about 10 microns to about 300 microns on the surface of the fertilizer granules. In yet another embodiment, the coating matrix may form a film having a thickness in a range of form about 50 microns to about 200 microns on the surface of the fertilizer granules. In one embodiment, the coating matrix may completely cover each fertilizer granule. In one embodiment, the coating matrix may partially cover each fertilizer granule.

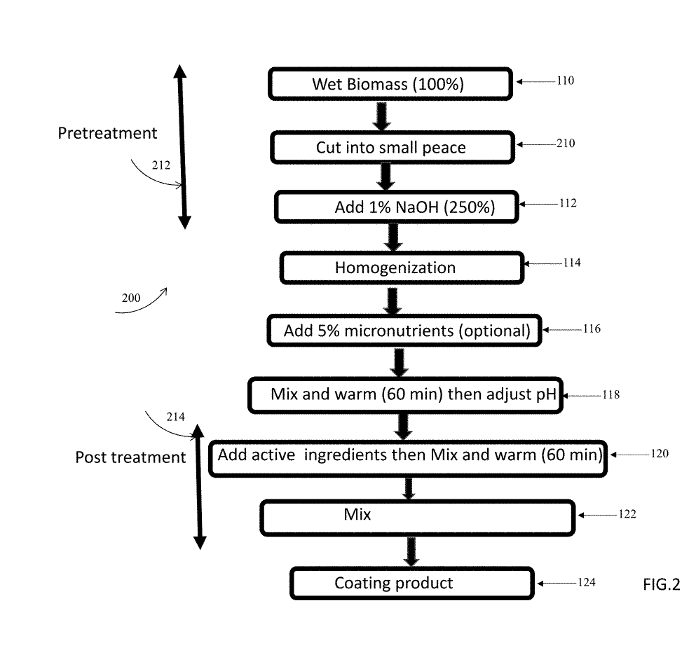

In another embodiment, a method for manufacturing the coating matrix and using the coating matrix to manufacture a coated fertilizer product is provided. Referring to FIG. 2 is provided a process flow chart 200 for the manufacturing of a coating matrix in accordance with an embodiment of the present invention. The process is similar to that described with reference to FIG. 1 except in that the process includes a pre-treatment step portion 212 which includes an additional step 210 where the wet biomass may be cut into small pieces using knife. In the post-treatment portion 214, step 120 of FIG. 2 includes one portion similar to that of spit 120 in FIG. 1, i.e., addition of active ingredients. However, FIG. 2 includes another step of mixing and warming for 60 minutes. In one embodiment, the warming may be held at a temperature in a range of from about 30 degrees Celsius to about 70 degrees Celsius. In another embodiment, during coating the fertilizer granules may be held at a temperature in a range of from about 35 degrees Celsius to about 60 degrees Celsius. In yet another embodiment, during coating the fertilizer granules may be held at a temperature in a range of from about 40 degrees Celsius to about 60 degrees Celsius. The warming time in one embodiment, during coating the fertilizer granules may be held at a temperature in a range of from about 5 min to about 72 h. In another embodiment, warming may be held at a temperature in a range of from about 30 min to about 12 h. In yet another embodiment, warming may be held at a temperature in a range of from about 45 min to about 120 min.

In one embodiment, granulated fertilizers are coated using the coating matrix. It may be appreciated by a person with ordinary skill in the art, in light of and in accordance with the teachings of the present invention that the coating may be carried out by processes known in the art.

In one embodiment, during coating the fertilizer granules may be held at a temperature in a range of from about 30 degrees Celsius to about 70 degrees Celsius. In another embodiment, during coating the fertilizer granules may be held at a temperature in a range of from about 35 degrees Celsius to about 60 degrees Celsius. In yet another embodiment, during coating the fertilizer granules may be held at a temperature in a range of from about 40 degrees Celsius to about 60 degrees Celsius.

In one embodiment, during coating the coating matrix may be held at a temperature in a range of from about 30 degrees Celsius to about 70 degrees Celsius. In another embodiment, during coating the coating matrix may be held at a temperature in a range of from about 35 degrees Celsius to about 65 degrees Celsius. In yet another embodiment, during coating the coating matrix may be held at a temperature in a range of from about 40 degrees Celsius to about 60 degrees Celsius.

In one embodiment, particles are granulated, powder or liquid fertilizer products comprising at least one of the following: a phosphate base material portion, a silica base material portion, a biofertilizer base material portion, a micronutrient base material portion, at least one nutrient selected from a compound consisting of a micronutrient, a secondary nutrient, and a secondary nutrient base material. In one embodiment, the particles are phosphorus product, silica, biofertlizers, coal etc. for example monoammonium phosphate (MAP), diammonium phosphate (DAP), and nitrogen (N), phosphorus (P), urea and potassium (K) called NPK, silica, microorganisms, water soluble fertilizers or pesticides.

### EXPERIMENTAL SECTION

### Example 1:Preparation of a Coating Matrix in Accordance with Embodiments of the Present Invention

In an embodiment, whole biomass components are used to provide a homogenized product. The process is homogenization of whole algal biomass. The process is grinding or crushing the biomass in high pH solution to initiate a cell lysis then cell components disintegration and separation to create a homogenous viscous matrix.

Whole Biomass used in the preparation of homogenized product may be best handpicked from the coastal area. The whole biomass included macroalgae samples. For example, brown algae Cystoseira sp. at the size between about 10 to about 30 cm. Unwanted impurities like sand, shells, soil, small rocks, etc. were removed from the wet biomass using seawater then transported to a processing station. The whole biomass was used right way. Once the whole biomass is brought to the processing station it is again washed with tap water to remove salt water. The wet biomass is then mixed with a 1 percent NaOH or KOH solution in a ratio of about wet biomass:1 percent NaOH::10:1 weight by volume to provide an alkaline biomass. To the resultant alkaline biomass water is added in a ratio of about 2.5:1 volume by weight of the alkaline biomass to form a mixture. In case of dry water, the alkaline biomass water is added in a ratio 7.5:1 (see drawing FIG. 1). The resultant mixture is then homogenized in a grinder to form a slurry. The NaOH solution and water may be added before the grinding or during the grinding. The addition during the grinding may be in one time or continuously as needed. The tissue grinder homogenizer used is overhead stirrer providing RPM/Torque combination with RPM control (300-5000) from Omni International (GA, USA). After a visual control show a full biomass homogenization, there is a filtration step to make sure that there is no contamination. Contaminants may include but not limited to sand, particles, shells debris, non-homogenized tissue, etc.). The coating matrix comprises only fully homogenized material. The resultant slurry is filtered. The pH of the slurry is the adjusted to a value in the range of from about 7 pH and 9 pH using hydrochloric acid. All organic and inorganic acids may be used for pH adjustment. In an example, HCL stock solution (0.5N) may be added in batch at approximately 100 microL by 100 microL with continuous mixing to allow a pH adjustment in the whole blend. This mixing may be performed by a grinder homogenizer. Micronutrients such as zinc, magnesium and ferric metals may be added at the ratio range between about 0.01% to 5%. Other micronutrients components may be added as needed. The viscosity of the slurry may be maintained over about 100 centipoise (cp) at a temperature of about 25 degree Celsius. Ten percent of vegetable oil and glycerol may be added to the slurry volume by volume based on the amount of slurry. Vegetable oil and glycerol may be added as a dispersant to improve the viscosity and quality of the coating matrix (web blend). The resultant mixture was mixed and warmed. It is a continuous steering at 60 degree Celsius during the process to spread oil in the matrix and allow a kind of homogeneity. The temperature may be about 25 degree Celsius to about 100 degree Celsius. The temperature may be about 35 degree Celsius to about 80 degree Celsius. The temperature may be about 42 degree Celsius to about 60 degree Celsius. The oil is mainly for the dust control of coated particles and also a liaison agent between matrix polymers (the higher temperature is the more matrix component separation followed by inter and intra liaison using metallic ions such as zinc and also oil. Temperature may not be over 65 degree Celsius to ovoid advanced melting which affect the quality and viscosity of the matrix) and held at a temperature of about 60 degree Celsius for about 60 minutes before its application as a coating matrix.

### Example 2: Coating of Granulated Fertilizers in Accordance with Embodiments of the Present Invention

Granulated fertilizers were held as follow: One kilogram (Kg) of Triple Super Phosphate (TSP) was held at a temperature of about 40 degree Celsius before commencing the coating process till all granules reach a temperature of about 40 degrees Celsius. The internal sample temperature was measured by a bimetal thermometer. One Kg of each granular MAP, monoammonium phosphate (MAP), diammonium phosphate (DAP), and nitrogen (N), phosphorus (P), urea and potassium (K) called NPK respectively] was held at a temperature of about 60 degrees Celsius before commencing the coating process till all these granule reach a temperature of about 60 degrees Celsius. The temperature may be about 20 degree Celsius to about 100 degree Celsius. In another embodiment, the temperature may be about 35 degree Celsius to about 70 degree Celsius. In another embodiment, the temperature may be about 40 degree Celsius to about 60 degree Celsius. 3 grams (g) of the coating matrix prepared in Example 1, was sprayed on the fertilizer granules. Immediately prior to application to the fertilizer granules, the coating matrix was heated to a temperature of about 60 degrees Celsius as mentioned in Example 1. After spraying of the coating matrix, the resultant coated TSP, MAP, DAP et NPK granules are held for at least a period of about 24 hours (hr) before analysis. The coating matrix was then sprayed onto 1 kg of fertilizer particles that were kept moving in a rotating drum (35 rpm, diameter 25 cm, length 15 cm) at a temperature of 30° C. Only one spray (monolayer) may be required. Each coating procedure was performed separately on each fertilizer. They are not (DAP, MAP, TSP and NPK) mixed together to be coated. It is an instant drying at this temperature in the rotating system.

### Example 3: Anti-Dusting Effect of the Coating Matrix on the Granulated Fertilizers was Determined in Accordance with the Embodiments of the Present Invention

Dust generation by coated particles was estimated by using a filter bag on the top of a blower device. A vertical air flow was produced from the bottom by the blower to shake particles. The test was performed on a weight of about 200 g of particles for about 30 min at room temperature 25 degree Celsius. The whole sample was sieved. The dust and debris were collected at the end and weighted.

Results showed a significant anti-dusting effect of the coating film MB8 and MB9. MAP granules as provided in Table 1. The dust was reduced by about 61.73 percent and 60.49 percent in MAP granules respectively coated by MB8 and MB9 in comparison to coated granules available in the market (MAP from OCP Group S.A., Morocco) (53.09 percent). Similar effects were observed with TSP granules, dust was reduced by 71 percent (MB8) and 69 percent (MB9) and commercial TSP granules by 70 percent TSP from OCP Group S.A., Morocco].

TABLE 1
Anti-dusting effects of the coating material on granules.

| Fertilizer | | Dust | Dust reduction |
|---|---|---|---|
| particles | Treatment | collected (g) | (percentage) |
| MAP | Coated granules with MB 8 | 0.31 | 61.73 |
| | Coated granules with MB 9 | 0.32 | 60.49 |
| | Commercial coated granules | 0.38 | 53.09 |
| | None coated granules | 0.81 | 0 |
| DAP | Coated granules with MB 8 | 0.39 | 25.00 |
| | Coated granules with MB 9 | 0.34 | 34.62 |
| | Commercial coated granules | 0.48 | 7.69 |
| | None coated granules | 0.52 | 0 |
| NPK | Coated granules with MB 8 | 0.49 | 39.51 |
| | Coated granules with MB 9 | 0.5 | 38.27 |
| | Commercial coated granules | 0.7 | 13.58 |
| | None coated granules | 0.81 | 0 |
| TSP | Coated granules with MB 8 | 0.29 | 71 |
| | Coated granules with MB 9 | 0.31 | 69 |
| | Commercial coated granules | 0.3 | 70 |
| | None coated granules | 1 | 0 |

### Example 4: Anti-Caking Effect of the Coating Matrix on the Granulated Fertilizers was Determined in Accordance with the Embodiments of the Present Invention

The anti-caking effect of the film formed by spraying the coating matrix was performed using a high speed benchtop centrifuge. Twenty grams of granules were packed in polyethylene bags in a cylinder then centrifuged at 3200 rpm for about 3 hours. Granules dispersion strength of the granules in the bag was evaluated using particles crushing strength tester.

Results showed a significant anti-caking effect of the coating film MB8 and MB9 in DAP granules as shown in Table 2. The caking index was reduced by about 79.06 percent and 84.06 percent with DAP granules respectively coated by MB8 and MB9 in comparison to coated granules available in the market that had a caking index of 59.38 percent. Caking index was also reduced with coated TSP granules. It was reduced by 77.23 percent (MB8) and 73.27 percent (MB9) in comparison to commercial TSP granules that had a caking index of 81.19 percent. Anti-caking property is a requested and desirable characteristic during the storage, transport and livraison.

TABLE 2
Anti-caking effects of the coating material on granules.

| | | Anti-caking | |
|---|---|---|---|
| Fertilizer | | indicator | Caking |
| particles | Treatment | (Kgf) | reduction (%) |
| DAP | Coated granules with MB 8 | 6.7 | 79.06 |
| | Coated granules with MB 9 | 5.1 | 84.06 |
| | Commercial coated granules | 13 | 59.38 |
| | None coated granules | 32 | 0 |
| NPK | Coated granules with MB 8 | 2.3 | 77.23 |
| | Coated granules with MB 9 | 2.7 | 73.27 |
| | Commercial coated granules | 1.9 | 81.19 |
| | None coated granules | 10.1 | 0 |

### Example 5: Crushing Strength of the Coating Matrix on the Granulated Fertilizers was Determined in Accordance with the Embodiments of the Present Invention

The crushing strength is considered an index and used to characterize granule hardness. For each experiment, 200 granules were sampled from the final coated products, then sieved to subdivide the sample into subpopulations based on their diameter. A micrometer (0 to 25 millimeter, 163 accuracy 10 meter) was used to measure their diameters. A particle crushing strength tester (Yinhe Instrument Factory, Jiangyan, China) was used to measure the granule crushing strength. The device applies an increasing compressive force on each single granule, and records the compressive force when the granule was crushed. Newton is the unit used for the granule crushing strength in the fertilizer industry. Data from granule strength versus diameter was recorded.

The strength to crushing was improved by using MB8 and MB9 coating matrix on MAP, DAP, NPK and TSP granules in comparison to coated and none coated MAP, DAP, NPK and TSP available in the market, as provided in Table 3.

TABLE 3
Effects of the coating material on granules crushing strength

| Fertilizer | | Crushing strength |
|---|---|---|
| particles | Treatment | (Kgf) |
| MAP | Coated granules with MB 8 | 6.3 |
| | Coated granules with MB 9 | 6.2 |
| | Commercial coated granules | 5.9 |
| | None coated granules | 5.7 |
| DAP | Coated granules with MB 8 | 7.6 |
| | Coated granules with MB 9 | 7.4 |
| | Commercial coated granules | 6 |
| | None coated granules | 6.6 |
| NPK | Coated granules with MB 8 | 5.5 |
| | Coated granules with MB 9 | 5.2 |
| | Commercial coated granules | 4 |
| | None coated granules | 4.1 |
| TSP | Coated granules with MB 8 | 5.4 |
| | Coated granules with MB 9 | 5.2 |
| | Commercial coated granules | 4.2 |
| | None coated granules | 5 |

### Example 6: Humidity Holding Capacity of the Coating Matrix on the Granulated Fertilizers was Determined in Accordance with the Embodiments of the Present Invention

The humidity holding capacity of the coating matrix surrounding the granulated fertilizer particles was verified by using a moisture content analysis where weight loss of the coated particles at 62 degrees Celsius was determined. Data provided in Table 4 shows an improved humidity hold by film developed using MB8 and MB9.

TABLE 4
Granules moisture content

| Fertilizer | | Moisture content |
|---|---|---|
| particles | Treatment | (%) |
| MAP | Coated granules with MB 8 | 4.2 |
| | Coated granules with MB 9 | 4.3 |
| | Commercial coated granules | 4.8 |
| | None coated granules | 5.8 |
| DAP | Coated granules with MB 8 | 5.0 |
| | Coated granules with MB 9 | 7.0 |
| | Commercial coated granules | 8.6 |
| | None coated granules | 8.9 |
| NPK | Coated granules with MB 8 | 4.9 |
| | Coated granules with MB 9 | 5.0 |
| | Commercial coated granules | 0.9 |
| | None coated granules | 1.22 |
| TSP | Coated granules with MB 8 | 2.9 |
| | Coated granules with MB 9 | 3.1 |
| | Commercial coated granules | 2.9 |
| | None coated granules | 3.9 |

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112 (6) when such corresponding structures are not explicitly disclosed in the foregoing patent specification. Therefore, for any invention element(s)/structure(s) corresponding to functional claim limitation(s), in the below claims interpreted under 35 USC § 112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative coating matrixes and methods of preparing and applying the same according to the present invention will be apparent to those skilled in the art. Various aspects of the invention have been described above by way of illustration, and the specific embodiments disclosed are not intended to limit the invention to the particular forms disclosed. The particular implementation of the coating matrix and methods of preparing and applying the same may vary depending upon the particular context or application. By way of example, and not limitation, coating matrix and methods of preparing and applying the same described in the foregoing were principally directed to fertilizer implementations; however, similar techniques may instead be applied to which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. A process for the production of a coating matrix comprising:
preparing said coating matrix from at least a whole biomass composition;
pretreating said whole biomass composition, in which said whole biomass composition comprises a microalgae and a macroalgae;
reducing the size or dimension of said whole biomass composition;
homogenizing said whole biomass composition, in which said homogenizing step comprises adding an aqueous solution of alkali metal hydroxide or alkaline earth metal hydroxide at a concentration ranging from 0.1% to 20% (w/v) to said whole biomass composition to form an alkaline mixture; and
mixing said alkaline mixture at about 7 pH to about 9.5 pH, in which said homogenized biomass composition comprises cross-linked polysaccharides.

2. The method of claim 1, in which said whole biomass composition further comprises at least a whole seaweed biomass.

3. The method of claim 2, wherein said microalgae is filamentous and unicellular, and wherein said microalgae comprises at least one of, a Botryococcus genera Chlorella, a Skeletonema, a Thalassiosira, a Phaeodactylum, a Chaetoceros, a Cylindrotheca, a Euglena, a Bellerochea, a Actinocyclus, a nitzchia, a Cyclotella, a Isochrysis, a Pseudoisochrysis, a Dicrateria, a Monochrysis, a Tetraselmis, a Pyramimonas, a Micromonas, a Chroomonas, a Cryptomonas, a Rhodomonas, a Chlamydomonas, a Olisthodiscus, a Carteria, a Dunaliella, a Spirulina and a Nannochloropsis.

4. The method of claim 2, wherein said macroalgae comprises at least a brown algae, red algae and green algae.

5. The method of claim 4, wherein said brown algae comprises at least one of, a Laminariales orders, a Macrocystis, a Fucales, a Ectocarpales, a Chordariales, a Dictyotales, a desmarestiales, a Scytosiphonales, a Dictyosiphonales and a Sargassum.

6. The method of claim 4, wherein said brown algae comprises at least one of, a Cystoseira genres, a Bifucaria, a Nerocystis, a Ectocarpus, an Ulva, a Pophyra, a Palmaria, a Lithothamnion and an Ascophyllum.

7. The method of claim 2, in which said microalgae and macroalgae are processed wet.

8. The method of claim 2, in which the microalgae and macroalgae are processed dry.

9. The method of claim 7, wherein whole biomass composition is washed, followed by cutting into pieces of small size of up to 1 mm.

10. The method of claim 8, wherein said whole biomass composition is reduced to powder form by grinding.

11. The method of claim 2, wherein the major cell components comprises at least 0.1% to 75% lipids, 0.1% to 70% protein, and 0.1% to 70% carbohydrates.

12. The method of claim 11, wherein secondary cellular components comprises vitamin traces, traces of growth hormones including cytokines, gibberellins, and auxins, polyphenol traces, pigments (0.01 to 14%), 6%, metal ions from 0.01 to 0.2%.

13. The method of claim 2, further disintegrating cellular components comprising carbohydrates, polysaccharides, vitamins, lipids, proteins, growth hormones, mineral salts, fatty acids, starches, sugars, peptides, Amino acids, nucleic acids, metal ions, polymers, oligomers, and monomers.

14. According to claim 13, further comprising solubilization of a base selected from the group consisting of sodium hydroxide, potassium hydroxide, calcium hydroxide, alkali metals, alkaline earth metals, Ammonium hydroxide, ammonia, sodium carbonate, potassium carbonate, boron hydroxide, aluminum hydroxide, borax, amino alcohols such as ethanolamine, diethanolamine, Triethanolamine, isopropanolamine, diisopropylamine, triisopropylamine, propyl amine, 2-propylamine, methyl amine, dimethylamine, trimethylamine, dimethylethanolamine, monoethylethanolamine, 2-(2-aminoethoxy) ethanol, diglycolamines, Diethylamine and a mixture thereof with a concentration ranging from 0.1% (w/v) to 10%.

15. The method of claim 2, further comprising the step of adding inorganic salt and metal ion including at least one of, a zinc, an iron and a magnesium, wherein said inorganic salt and metal ion are operable to act as bonding agent between a polymers and an oligomer to form a coating matrix with a viscous structure.

16. The method of claim 2, wherein said coating matrix comprises polymers, monomers, oligomers, vitamins, enzymes carbohydrate, minerals, ions, amino acids, growth hormone, fatty acids, nucleic acids, water, oils, glycerol, micronutrient, and antioxidants.

17. A coating matrix comprising:
a whole biomass composition, in which said whole biomass composition comprises at least a microalgae and a macroalgae, wherein the size of said whole biomass composition is reduced to a powder composition;
an aqueous solution of alkali metal hydroxide or alkaline earth metal hydroxide at a concentration ranging from 0.1% to 20% (w/v), wherein said aqueous solution of alkali metal hydroxide or alkaline earth metal hydroxide is mixed with said whole biomass composition to form an alkaline mixture; and
a cross-linked polysaccharide, wherein said alkaline mixture is mixed at about 7 pH to about 9.5 pH which produces said cross-linked polysaccharide.

18. The coating matrix of claim 17, wherein said coating matrix is used for fertilizer particle coating, in which said fertilizer particle comprises at least one of, a phosphate-based fertilizer, a silica based fertilizer, a biofertilizer, and a micronutrient-based fertilizer.

19. A process comprising:
preparing a coating matrix from at least a whole biomass composition;
pretreating said whole biomass composition, in which said whole biomass composition comprises at least one of, a microalgae and a macroalgae;
reducing the size or dimension of said whole biomass composition to a powder composition;
homogenizing said whole biomass composition, in which said homogenizing step comprises adding an aqueous solution of alkali metal hydroxide or alkaline earth metal hydroxide at a concentration ranging from 0.1% to 20% (w/v) to said whole biomass composition to form an alkaline mixture; and
mixing said alkaline mixture at about 7 pH to about 9.5 pH, in which said homogenized biomass composition comprises cross-linked polysaccharides.

20. The process of claim 19, further comprising the step of applying said coating matrix for coating fertilizer particles.
